(19) United States
(12) Patent Application Publication
(10) Pub. No.: US 2024/0318544 A1
(43) Pub. Date: Sep. 26, 2024

(54) WELL MONITORING SYSTEM AND METHOD

(71) Applicant: BlueCap Co., Spokane, WA (US)

(72) Inventors: Andrew PETERS, Chewelah, WA (US); Ryan C. Stocket, Spokane, WA (US)

(73) Assignee: BlueCap Co., Spokane, WA (US)

(21) Appl. No.: 18/614,486

(22) Filed: Mar. 22, 2024

Related U.S. Application Data
(60) Provisional application No. 63/492,045, filed on Mar. 24, 2023.

(51) Int. Cl. E21B 47/107; E03B 5/06; E21B 47/047; E21B 47/07; G01F 1/66

(52) U.S. Cl. CPC E21B 47/107; E03B 5/06; E21B 47/047; E21B 47/07; G01F 1/662

(57) ABSTRACT

A system is disclosed for monitoring a well having a pump disposed within a bore to pump fluid out of the bore through a pipe. The system may include a sensing unit having a device that is remotely operatable to press at least one sensor toward the pipe. The at least one sensor may be configured to generate a flowrate signal indicative of a flowrate of the fluid through the pipe. The system may also include a hub connected to the sensing unit and configured to receive the signal.

### RELATED APPLICATIONS

This application is based on and claims the benefit of priority from U.S. Provisional Application No. 63/492,045 that was filed on Mar. 24, 2023, the contents of which are expressly incorporated herein by reference.

### TECHNICAL FIELD

The present disclosure relates generally to a monitoring system and method and, more particularly, to a system and method for monitoring a well.

### BACKGROUND

Wells have a long history of use for producing potable water. Wells can be hand-dug, drilled (a.k.a., bored), or driven to access underground aquifers. Water from these aquifers is typically pumped into a consuming facility (e.g., a residence, commercial building, school, etc.) that is connected to the well via corresponding pipes, and stored in local vessels (e.g., pressure tanks, water towers, cisterns, etc.) for later use. Nearly 50% of the U.S. population rely on a well as their primary source of water.

A well is healthy only when a sufficient supply of water is available, the components of the well are selected properly and fully functioning, and the water is free of contamination. Testing can be performed to measure the health of a well. While testing is generally performed at commissioning of a new well (e.g., to assist in the selection of well components), wear of the components and/or environmental changes may require additional testing. Testing allows for diagnostics, repairs, and adjustments to be made that inhibit costly failures of the well and leave a consumer without water for an extended period. Risks to the well-being of the consumer may also be avoided and/or corrected via testing. In some regions, testing is a requirement before a real estate transaction can be completed. This may provide peace of mind for a new home buyer and/or lender that the transaction will maintain its value.

During a conventional test, a home inspector or other handyman will access the well, initiate production (e.g., by turning on an outdoor spigot), and attempt to drawdown the amount of water in the well (e.g., to “stress the well”). Typically, the well remains operational for four or more hours when being tested. A 5-gallon bucket is then manually placed to catch the water from the spigot, and a time required to fill the bucket is measured (e.g., via a stopwatch). The goal of this is to determine a rate at which the well is replenished with water from the ground surrounding the well.

While the conventional “4-hr drawdown test” may be adequate for some situations, it can also be problematic. For example, if the well is not adequately drawn down and stabilized before the bucket is filled, the results of the test may more accurately reflect a capacity of the pump and not performance of the well. In addition, a typical 5-gallon bucket holds more than five gallons and does not have graduated markings, making it impossible to accurately measure an amount of water in the bucket. This introduction of error can be further compounded by the inspector or handyman being unable to manually start the timer and filling of the bucket at precisely the same moment and likewise stop the timer and filling of the bucket at precisely the same moment. Further, even if all of this error could be avoided, the only information provided by this test is a recovery rate of the well at a single instant. This limited amount of information may prohibit any diagnostic capability associated with components of the well or detection of long-term changes in the associated aquifer.

The disclosed system and method are directed at addressing one or more of these issues and/or other problems of the prior art.

### SUMMARY

In a first aspect, the present disclosure is directed to a system for monitoring a well having a pump disposed within a bore to pump fluid out of the bore through a pipe. The system may include a sensing unit having a device that is remotely operatable to press at least one sensor toward the pipe. The at least one sensor may be configured to generate a flowrate signal indicative of a flowrate of the fluid through the pipe. The system may also include a hub connected to the sensing unit and configured to receive the signal.

In another aspect, the present disclosure is directed to another system for monitoring a well having a pump disposed within a bore to pump fluid out of the bore through a pipe. This system may include a sensing unit configured to generate a flowrate signal indicative of a flowrate of the fluid through the pipe. The system may also include a hub in communication with the sensing unit and programmed to determine a depth of water in the bore based on the flowrate signal and an amount of power consumed by the pump.

In yet another aspect, the present disclosure is directed to a method of monitoring a well. The method may include using a sensing unit located inside of a well casing to generate a flowrate signal indicative of a flowrate of water pumped by a pump submerged in the well. The method may also include using a hub located remotely from the sensing unit to determine a depth of water in the well based on the flowrate signal.

### BRIEF DESCRIPTION OF THE DRAWINGS

FIG. 1 is a diagrammatic illustration of an exemplary disclosed well and associated monitoring system;

FIGS. 2, 3, and 4 are diagrammatic illustrations of an exemplary disclosed sensing unit that may form a portion of the monitoring system of FIG. 1;

FIG. 5 is an exploded view illustration of the sensing unit of FIGS. 2-4;

FIG. 6 is an exploded view illustration of an exemplary disclosed hub that may form a portion of the monitoring system of FIG. 1;

FIG. 7 is a schematic of a processing system that may form a portion of the monitoring system of FIG. 1;

FIGS. 8, 9, and 10 are diagrammatic illustrations of another exemplary disclosed sensing unit that may form a portion of the monitoring system of FIG. 1;

FIGS. 11 and 12 are diagrammatic illustrations of another exemplary disclosed hub that may form a portion of the monitoring system of FIG. 1; and

FIG. 13 is a chart depicting an example process that may be performed and/or used by the processing system of FIG. 7.

### DETAILED DESCRIPTION

The term “about” as used herein serves to reasonably encompass or describe minor variations in numerical values measured by instrumental analysis or as a result of sample handling. Such minor variations may be considered to be “within engineering tolerances” and in the order of plus or minus 0% to 10%, plus or minus 0% to 5%, or plus or minus 0% to 1% of the numerical values.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more.

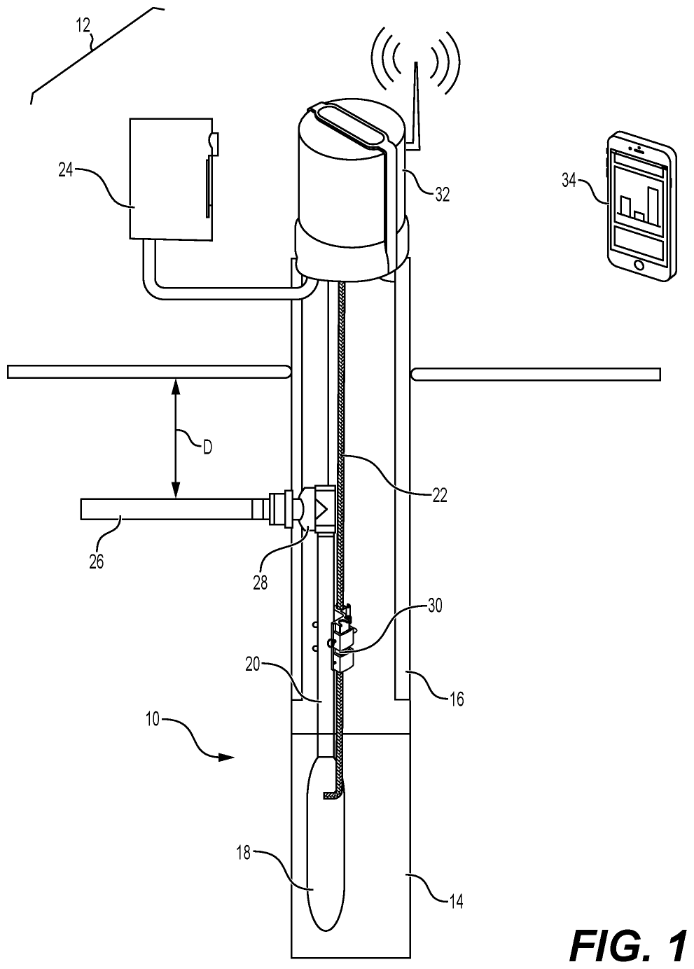

FIG. 1 illustrates a water well 10, and an exemplary monitoring system 12 that may be used to monitor the performance and/or health of well 10 over an extended period of time. Well 10 may include, among other things, a bore 14 that has been dug, drilled, or driven into the earth, a casing 16 that extends only part or all the way along an axial length of bore 14, a pump 18 disposed at a depth inside of casing 16 and/or bore 14, a downpipe 20 that extends axially inside of bore 14 to pump 18, and a power line 22 that connects an external pump controller 24 to pump 18. It is contemplated that other components (e.g., screens, clamps, fittings, adapters, filters, etc.) may also be included, if desired. As will be explained in more detail below, system 12 may be configured to monitor various aspects of well 10 and/or a geographical area surrounding well 10.

Casing 16 may be a generally hollow tube placed inside of bore 14 during or after formation of bore 14. Casing 16 may be prefabricated from a variety of different materials and have a variety of different shapes and sizes. For example, casing 16 may be fabricated from a plastic (e.g., polyvinylchloride-PVC), a composite material, steel (e.g., galvanized steel-GS), and/or concrete. Some portions of casing 16 may have a generally solid annular surface to inhibit surrounding earthen material from falling into bore 14, while other portions may be perforated to allow water to seep through casing 16 into bore 14. A size and/or number of the perforations (not shown) may vary based on the makeup of the earth surrounding casing 16 at a particular depth. An inner diameter of casing 16 may vary from about 4-20 inches or larger. Bore 14 and/or casing 16 may extend to any desired depth, to a depth that is dependent on the surrounding conditions (e.g., water tables), and/or to a depth prescribed by a regulatory agency.

Pump 18 may embody any type of pump that is submersible within a water column contained in casing 16 and/or bore 14. For example, pump 18 may be a piston pump, an impeller pump, or another type of pump that has a fixed or variable displacement and a fixed or variable rate. Pump 18 may be placed down through casing 16 into bore 14 to a location below a lowest level of water expected throughout a life of well 10, such that pump 18 is always provided with water from the surrounding environment. Pump 18 may hang from downpipe 20 into the water column. In some embodiments, depending on a depth of pump 18 and a type of material of downpipe 20, one or more clamps (not shown) may connect downpipe 20 to casing 16 to help support the weight of pump 18.

Downpipe 20 may be continuous or provided as separate lengths (e.g., 10 ft lengths, 20 ft lengths, etc.) that are joined (e.g., threaded and/or glued) together as pump 18 is lowered into casing 16. Downpipe 20 may be fabricated from PVC, GS, a composite material, or another material known in the art. Downpipe 20 may be available in standardized pressure ratings known as schedules (e.g., schedule 40, schedule 80, schedule 120, etc.) and standardized outer diameters (e.g., 1 inch, 1.25 inch, etc.). A wall thickness of downpipe 20 may vary based on the schedule and/or the outer diameter. An effective thickness of the pipe wall may also increase over time as minerals or other contaminates build up and coat an inner wall of downpipe 20.

Downpipe 20 may generally stop short of the open end of bore 14 (i.e., the end exposed to the atmosphere) to reduce a likelihood of the water in downpipe 20 freezing and cracking downpipe 20. For example, downpipe 20 may terminate a distance D below the ground surface. The distance D may vary based on a frost depth for a particular geographical area. For example, the distance D may range from about 4-8 feet or more.

Another conduit 26 may extend from the upper termination point of downpipe 20, underground, to a consumer (e.g., to a water tower, a cistern, a pressure tank, etc. of a home, a school, a business, etc.—not shown) of the water produced by well 10. Conduit 26 may connect to downpipe 20 via any device known in the art (e.g., via a pitless adapter 28). Pitless adapter 28 may extend radially through casing 16 and, depending on the geometry of the specific device, may allow for pump 18 and downpipe 20 to be removed from casing 16 without having to dig around casing 16 and expose or disconnect conduit 26. With this arrangement, the water pumped out of well 10 generally does not pass up through the open end of casing 16, but instead is delivered vertically upward to pitless adapter 28, and then rerouted horizontally by pitless adapter 28 through casing 16 and into conduit 26.

Controller 24 may be located remotely from pump 18 (e.g., above ground) and configured to affect operation of pump 18 based on demands of the connected consumer. Power line 22 may extend from controller 24 over a lip of casing 16 and down through the column of water to a motor of pump 18. Based on a demand (e.g., low-pressure and/or low-level) signal from the consumer (e.g., from one or more sensors associated with the consumer—not shown), controller 24 may be configured to activate or increase activation of pump 18 via a change in power directed to the associated motor. Similarly, based on a high-pressure and/or high-level signal from the same or a different sensor associated with the consumer, controller 24 may be configured to deactivate or decrease activation of pump 18. The activations/deactivations of pump 18 may be accomplished by changing a displacement (e.g., an actual physical displacement such as a stroke length, a vane angle, etc.; an effective displacement such as a restriction, a spill or meter setting, etc.; and/or another displacement mechanism or technique known in the art) and/or changing a speed (e.g., a reciprocating speed, a rotating speed, etc.). The adjustments may be implemented mechanically, pneumatically, hydraulically, and/or electrically (e.g., via regulation of power supply voltage, amperage, frequency, resistance, etc. passing through power line 22).

System 12 may include components that cooperate to monitor, analyze, display, and/or transmit any number of test parameters associated with well 10 and/or the geographical area surrounding well 10. These components may include, among other things, a sensing unit (“unit”) 30 configured to mount inside of casing 16 at a location below pitless adapter 28 (e.g., between pitless adapter 28 and pump 18), and a hub 32 located above ground and remote from unit 30. In the disclosed embodiment, hub 32 functions as a cap for casing 16 (e.g., to seal and close off the open end of casing 16 from the surrounding environment). Hub 32 may additionally provide access to unit 30 and function to power unit 30, receive signals from unit 30, analyze the signals, monitor operation of pump 18, analyze operation of pump 18, interrupt operation of 18 (e.g., as regulated by controller 24), and/or communicate the signals, performance and/or analyses to one or more remote portals (e.g., computers, servers, smartphones, etc.) 34.

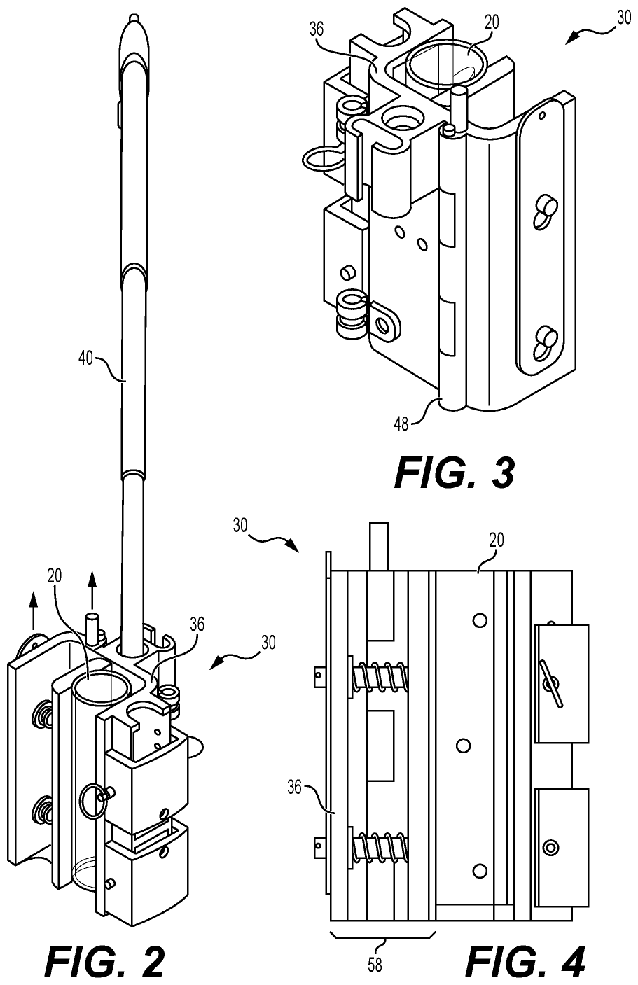

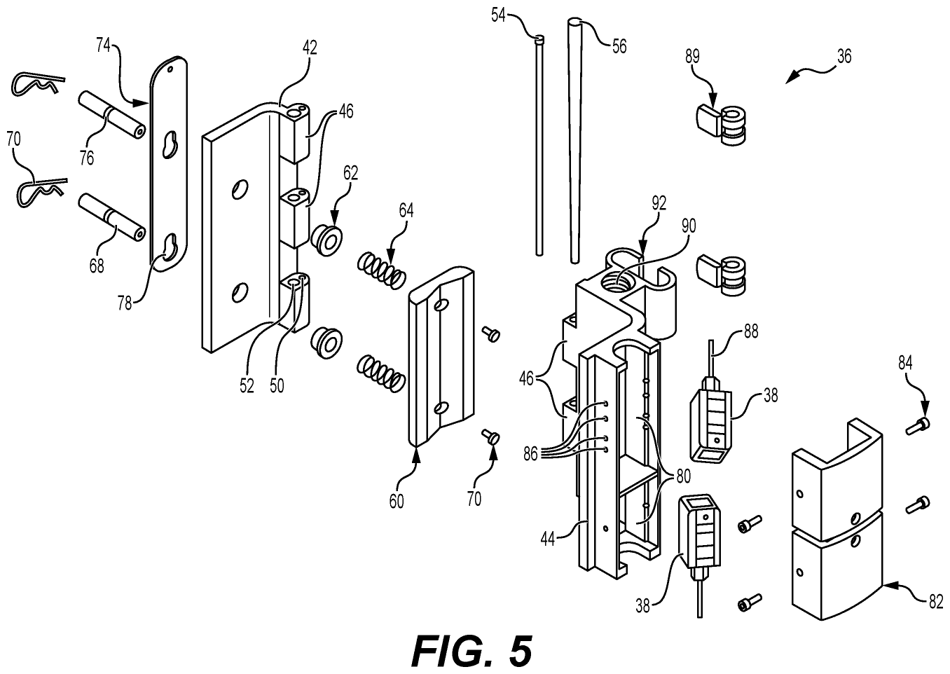

Unit 30 is shown in greater detail in FIGS. 2, 3, 4 and 5. As shown in these figures, unit 30 may include a clamp 36 configured to hold one or more (e.g., two) transducers 38 (shown only in FIG. 5) against downpipe 20, and a rod 40 (shown only in FIG. 2) used to position clamp 36.

As shown in the example embodiment of FIGS. 2-5, clamp 36 may resemble one or more hinges. For example, clamp 36 may include a first leaf 42 (referring to FIG. 5) and a second leaf 44 that are both elongated in an axial direction of downpipe 20 (referring to FIGS. 2-4). Leaves 42, 44 may each have a generally L-shaped cross-section and include transversely protruding portions 46 known as knuckles or bearings. Bearings 46 may protrude outward from a lengthwise edge of the associated leaves 42, 44, and be interleaved with each other to form a hollow cylindrical barrel 48 (see FIG. 3). Each bearing 46 may have a pivot passage 50 that aligns axially with other pivot passages 50 of other bearings 46, and a lock passage 52 that aligns axially with other lock passages 52 of other bearings 46. In the disclosed example, pivot passages 50 are located radially outward from lock passages 52 (e.g., relative to downpipe 20). In one example, pivot passages 50 have a smaller diameter than lock passages 52.

A pivot pin 54 may pass through pivot passages 50 of barrel 48, such that leaves 42, 44 are pivotable about pivot pin 54. A lock pin 56 may selectively be passed through lock passages 52 of barrel 48, to lock clamp 36 in a closed position and inhibit relative pivoting between leaves 42, 44. Pivot pin 54 may be generally cylindrical and have a cap at an exposed end (e.g., a gravitationally upper end of barrel 48). Lock pin 56 may be tapered (e.g., with a larger diameter at the gravitationally upper end), with or without a cap. The tapering of lock pin 56 may aid in removal of lock pin 56 from lock passages 52 of barrel 48 (e.g., during removal of unit 30 from downpipe 20).

A biasing mechanism 58 may be mounted to one or both of leaves 42, 44 and configured to bias unit 30 relative to downpipe 20 (referring to FIG. 4). As shown in the example of FIG. 4, biasing mechanism 58 is mounted to extend from an inner surface of leaf 42 toward leaf 44. Biasing mechanism 58 may include, among other things, an engagement member 60, at least one guide 62, and at least one biasing element 64.

Engagement member 60 may be elongated in the axial direction of downpipe 20 and configured to engage the outer annular surface of downpipe 20. In one embodiment, an inner surface of member 60 may be shaped to accommodate the annular shape of downpipe 20. For example, the inner surface may be at least partially concave, with an axis of the concavity that is generally parallel to an axis of downpipe 20. This concavity may be a smooth curved surface (e.g., a U-shaped surface), an angled surface (e.g., a V-shaped surface), or have another similar geometry. One or more (e.g., two) protrusions 68 may extend outward from an outer surface of member 60 (e.g., in a direction opposite of downpipe 20). In one example (shown in FIG. 4), protrusion(s) 68 are integral with member 60. In another example (shown in FIG. 5), protrusions 66 may be separate components (e.g., dowels, studs, bolts, etc.) assembled to member 60. One or more retention mechanisms (e.g., clips, pins, threaded fasteners, etc.) 70 may be used to retain protrusions 68 connected to member 60 and/or leaf 42.

Guides 62 may be mounted to leaf 42 and configured to guide protrusion(s) 68 during motion of member 60 towards and away from downpipe 20 (e.g., during assembly or disassembly of unit 30 to downpipe 20). In one embodiment, guide(s) 62 are bosses fitted into corresponding bores in leaf 42. As bosses, guide(s) 62 may be low-friction and/or bearing components that inhibit binding of protrusions 66 with leaf 42. It is contemplated that guide(s) 62 may have another configuration or be omitted, if desired.

Biasing element(s) 64 may be located and configured to bias member 60 radially inwards towards downpipe 20. This biasing may, in turn, urge leaf 42 away from downpipe 20 and leaf 44 (together with transducers) towards downpipe 20. In the disclosed embodiment, biasing element(s) 64 are associated with protrusion(s) 68. For example, each biasing element 64 may be a stand-alone component (e.g., a compression or tension spring) and operatively connected to (e.g., surrounding) one protrusion 68. It is contemplated, however, that other embodiments may be possible. For example, a single biasing element 64 could be associated with multiple protrusions 68 (e.g., located between adjacent protrusions 68) and/or formed integrally with member 60 and/or protrusions 68 (e.g., as a cantilevered and/or compliant extension of member 60 and/or protrusion 68).

A release mechanism 74 may be used to preload engagement member 60 in preparation for assembly to downpipe 20. In the disclosed embodiment, release mechanism 74 is configured to capture protrusion(s) 68 in a cocked position at which biasing element(s) 64 are loaded (e.g., compressed) and member 60 is in a retracted state towards and/or against leaf 42. At this position, sufficient clearance may be provided between leaves 42, 44 (e.g., between member 60 and leaf 44) for downpipe 20 to slide radially therebetween without significant (e.g., without any) friction. Protrusion(s) 68 may extend outward (e.g., radially outward relative to the axis of downpipe 20) through leaf 42 during this sliding operation.

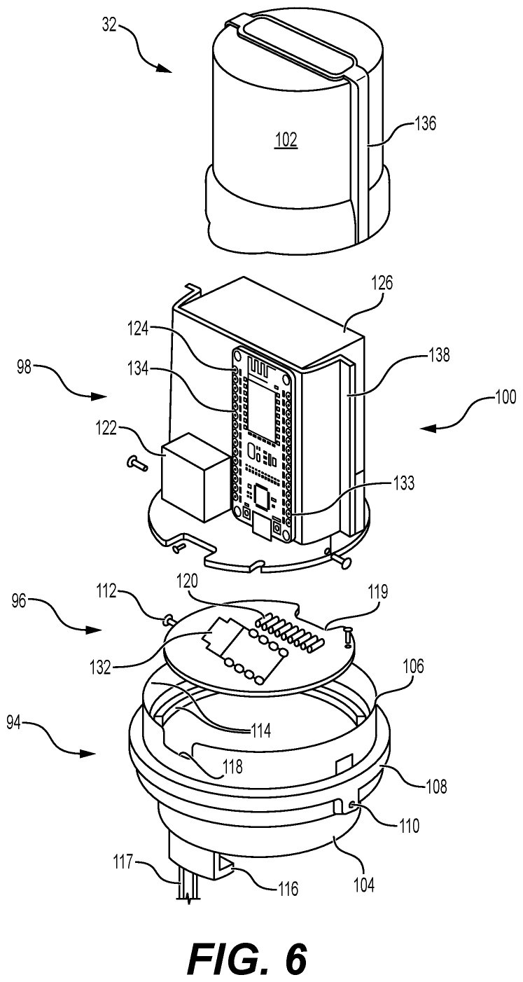

Any means may be used by release mechanism 74 to capture protrusion(s) 68 in their cocked position. In the disclosed embodiment, each protrusion 68 includes a first feature (e.g., a groove or recess) 76, and release mechanism 74 includes a corresponding second feature (e.g., a keyhole) 78 configured to engage and selectively interlock with the first feature 76. For example, when keyhole 78 is in a first position (e.g., when a smaller diameter of keyhole 78 encircles recess 76), protrusion 68 may be inhibited from extending radially inward toward downpipe 20. When keyhole 78 is in a second position (e.g., when a larger diameter of keyhole 78 encircles recess 76), protrusion 68 may be released and free to extend toward downpipe 20. During installation of unit 30, keyhole 78 may initially be in the first position, and a manual movement of release mechanism 74 (e.g., movement in a direction axially upward toward the open end of casing 16) may cause keyhole 78 to move toward the second position. This movement may be facilitated via pulling of a tether 117 (shown only in FIG. 6—explained in more detail below) that extends to the open end of casing 16.

Leaf 44 may be configured to retain transducer(s) 38 in a desired position (e.g., location and/or orientation) against the outer annular surface of downpipe 20. In the disclosed embodiment, two transducers 38 are illustrated as being located at the same side of downpipe 20 in an end-to-end and axially spaced-apart configuration. This configuration is known by one skilled in the art as a V-configuration. In this embodiment, a signal generated by each of transducers 38 is directed radially inward at an angle (e.g., a 45° angle) relative to a central axis of downpipe 20, and through a first side of downpipe 20 and the water flowing within downpipe 20. The signal may bounce off an opposing second side of downpipe 20 and reflect back toward the other of transducers 38 at roughly the same angle. In this configuration, the signal follows a path having the general shape of a V. A time of flight for each signal is calculated and used to determine a velocity of the water flowing through downpipe 20. It is contemplated that other configurations (e.g., a Z-configuration, a W-configuration, etc.) of transducers 38 may alternatively or additionally be utilized, if desired.

In the disclosed embodiment, leaf 44 includes one or more (e.g., two) pockets 80 to receive (e.g., separately receive) transducers 38, and one or more (e.g., two) covers 82 that close off open sides of pocket(s) 80. Any type of retention mechanism (e.g., a threaded fastener, a pin, a clip, etc.) 84 may be used to connect cover 82 to pocket 80 and/or to transducer(s) 38.

In one embodiment, a position (e.g., an axial location) of one or both of transducers 38 may be adjustable. For example, one transducer 38 (e.g., the lower transducer shown in FIG. 5) may have a fixed location, while the other transducer 38 (e.g., the upper transducer) may be adjustable to be closer or further away from the lower transducer 38 relative to an axial direction of downpipe 20. This adjustability may be provided by way of a plurality of (e.g., four) features (e.g., holes) 86 spaced apart in the axial direction. One or more of retention mechanisms 84 may be configured to engage features 86, cover 82 and/or transducer 38, thereby affixing the upper transducer 38 at a desired axial location relative to the lower transducer 38. Depending on which features 86 are used, transducers 38 may be set at axially spaced-apart locations that provide a greatest flow-rate accuracy for a given type/size of downpipe 20.

For example, when downpipe 20 is made from PVC and has an outer diameter of about 1 in, a first feature 86 that positions transducers 38 closest to each other should be used. When downpipe 20 is made from PVC and has an outer diameter of about 1.25 in, a second feature 86 that positions transducers 38 further apart should be utilized. When downpipe 20 is made from GS and has an outer diameter of about 1 in, a third feature that positions transducers 38 even further apart should be utilized. Finally, when downpipe 20 is made from GS and has an outer diameter of about 1.25 in, a fourth feature that positions transducers 38 furthest apart should be utilized. Other configurations may be possible.

Transducers 38 may be conventional ultrasonic-type sensors. Many different varieties and manufacturers of transducers 38 are available. In one example, each transducer 38 includes an electrical connection 88 to hub 32 (referring to FIG. 1). In the arrangement shown in FIG. 5, transducers 38 are arranged such that their corresponding electrical connections 88 extend away from each other in opposing directions. It is contemplated, however, that other arrangements are possible. In the depicted arrangement, the electrical connection 88 initially extending downward toward pump 18 from the lowest transducer 38 may be rerouted upward to join the upper electrical connection 88 and enter hub 32 in parallel. One or more retention mechanisms (e.g., electrical clips) 89 may be used to retain electrical connections 88 securely to unit 30.

Rod 40 (referring to FIG. 2) may be used to place unit 30 within casing 16. In one example, rod 40 is telescoping to accommodate different depths D below the ground surface (referring to FIG. 1). It is contemplated, however, that a rod 40 having a fixed length may alternatively be utilized, if desired. A fixed-length rod, though, may need to be oversized in length to reach the greatest depths D that might be encountered, and then removed after installation to allow for mounting of hub 32 to casing 16 without interference. In either configuration, rod 40 may connect to unit 30 in any desired manner. In one example, rod 40 includes a threaded tip configured to be received within a corresponding threaded bore 90 of unit 30. In this example, bore 90 is integrally formed with leaf 44 (e.g., adjacent barrel 48). It is contemplated, however, that bore 90 could be integrally formed with leaf 42 or be a separate and standalone feature affixed to any portion of unit 30.

In some embodiments, rod 40 may provide support to unit 30 after installation. For example, an upper or base end of rod 40 (i.e., the end opposite the threaded tip) may be connectable (e.g., via threading, a tether, etc.) to hub 32. In this embodiment, rod 40 may hang from hub 32 down into bore 14 and support at least a portion of the weight of unit 30. This may help to retain unit 30 at a desired axial location over a longer period of time, even when exposed to vibrations, varying water pressures, etc.

It is contemplated that rod 40 could additionally function as an electrical conduit, if desired. For example, connections 88 may be passed through rod 40 into hub 32 and thereby protected from damage or corrosion by rod 40. In these situations, retention mechanisms 89 may not be required.

It has been determined that, in some applications, power line 22 (referring to FIG. 1) may interfere with installation of unit 30. For example, power line 22 may spiral around downpipe 20 and block downpipe 20 from entering into the clearance between leaves 42, 44 described above. For this reason, a lead-guide 92 may be provided on some units 30. As shown in FIG. 5, guide 92 may have a generally C-shaped cross-section that is configured to at least partially surround power line 22. With this arrangement, power line 22 may be pushed into an interior of the C-shape prior to lowering unit 30 into bore 14. Thereafter, as unit 30 is lowered, guide 92 may function to divert power line 22 away from the opening between leaves 42, 44.

An example hub 32 is illustrated in FIG. 6. As illustrated in this example, hub 32 may be an assembly of components including, among other things, a collar 94 configured to engage the open end of casing 16, a high-voltage platform 96 disposed at a lower level inside of collar 94, a low-voltage mount 98 disposed at a higher level inside of collar 94, a processing system 100 connected to low-voltage mount 98, and a cap 102 configured to engage collar 94 and enclose the other components of hub 32.

Collar 94 may be generally tubular (e.g., circular and hollow), having a lower annular extension 104, an upper annular extension 106, and a skirt 108 located axially between lower and upper annular extensions 106. An outer diameter of extension 104 may be less than an inner diameter of casing 16, such that extension 104 may be inserted into the open end of casing 16. Skirt 108 may have a larger inner diameter than the outer diameter of extension 104 and the open end of casing 16, such that the open end of casing 16 may be received within a radial gap formed between extension 104 and skirt 108. One or more threaded bosses 110 or other connecting features may be located around a perimeter of skirt 108 and configured to receive corresponding set screws 112 to secure collar 94 to casing 16. One or more steps 114 may be formed inside of upper extension 104 and configured to support a perimeter of high-voltage platform 96 and/or low-voltage mount 98 (e.g., in an axially spaced apart configuration). In one embodiment, a tether ring 116 may extend downward from lower annular extension 104 further into casing 16 and be configured to securely receive any number of different tethers 117 that will be described in more detail below. A notch 118 formed within a side wall of upper annular extension 106 may function to receive and guide an upper end of power line 22 coming from pump controller 24.

High-voltage platform 96 may embody a generally circular disk. A recess 119 may be formed at a perimeter of high-voltage platform 96. With this configuration, an upper end of power line 22 (e.g., the end extending upward from pump 18) may be passed through recess 119 and onto high-voltage platform 96 for connection to a lug 120. A lower end of power line 22 (e.g., the end extending downward from pump control 24) may pass through notch 118 and onto high-voltage platform 96 for insertion into lug 120. Although not shown, electrical lines extending from unit 30 may pass through a second recess formed in the periphery of platform 96 (e.g., a recess clocked away from recess 119 to avoid signal interference from electrical pulses in power line 22).

Low-voltage mount 98 may be configured to axially stack on top of high-voltage platform 96. A space may be maintained between mount 98 and platform 96 to enclose high-voltage connections (e.g., connection to lug 120 and to a switch 130 described in more detail below).

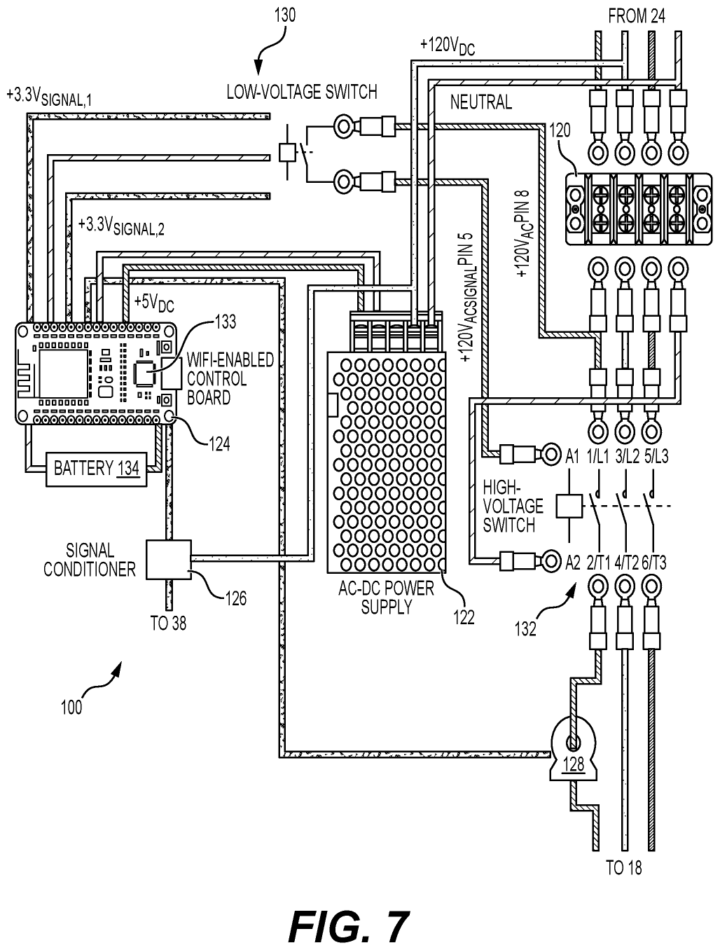

Processing system 100 is represented only generically in FIG. 6 as being mounted to low-voltage mount 98. FIG. 7 provides a schematic that more fully discloses the components and interconnections of processing system 100. As can be seen in this image, system 100 may include a power converter 122, a control board 124, a signal processor 126 associated with unit 30, a power sensor 128, and one or more (e.g., two) switches 130, 132. Power converter 122 may be configured to convert alternating current (e.g., a single phase of the power of about +120 V_{AC} provided by pump controller 24) to direct current (e.g., about +5 V_{DC}). The lower-voltage direct current may then be directed to control board 124 for use in powering other components of system 100. In some instances, the power from pump controller 24 may be intermittent. In these instances, a backup storage device (e.g., a battery) 134 may be provided to power control board 124 when pump controller 24 is not actively providing power via line 22. Battery 134 may be charged during active pumping.

Control board 124 may be a logic board having one or more processors 133 mounted thereon. Processor 133 may include, for example, multiple cores connected to a memory (a flash memory) and specially programmed for the disclosed application. Control board 124 may also accommodate a removable memory, if desired. For example, control board 124 may include a slot for a memory card, allowing for easy storage and retrieval of data by processor 133. The data may include, among other things quality limits, flowrates, pump settings, power supply requirements, well bore characteristics (e.g., static depth, dynamic depths, recovery rate, historical quality parameters, etc.), operational instructions, and corresponding parameters of each component of system 12.

One or more maps may be stored in the memory of control board 124 and used by processor 133 to regulate operations of system 12. Each of these maps may include a collection of the data in the form of lookup tables, graphs, and/or equations. Processor 133 may be specially programmed or otherwise configured via software and/or hardware to control an operation of system 12 using the maps. For example, processor 133 may be specially programmed to reference the maps and determine settings/operations of pumps 18 required to produce desired flowrates, pressures, depths, and/or water qualities, and to responsively monitor and/or coordinate operation of pump 18, unit 30, hub 32 and/or other components of system 12.

Additional peripheral devices may be mounted to control board 124 and used be processor 133 during performance of programmed operations. In the disclosed embodiment, control board 124 features built-in Wi-Fi, Bluetooth, and/or cellular connectivity, allowing processor 133 to communicate with other devices (e.g., with portal 34—referring to FIG. 1—via an HTTP server) over a wireless network. Control board 124 may also include a battery management system (BMS), which enables processor 133 to manage and charge battery 134. The BMS may include a battery protection circuit, which prevents overcharging, overdischarging, and short-circuiting of the battery.

Various other known circuits may be associated with control board 124, including power supply circuitry, signal-conditioning circuitry, driver circuitry, communication circuitry, and other appropriate circuitry. Any number and types of data, power and/or control ports may be associated with control board 124.

Processor 133 may communicate with unit 30 (e.g., with transducers 38) via signal processor 126. Together, transducers 38 and signal processor 126 may form an ultrasonic flow meter that is used to measure the flowrate of water in downpipe 20. Because transducers 38 are non-invasive, no physical contact with the water is required. This may reduce a number of changes required to retrofit an existing well 10 and reduce risk of system 12 contaminating or obstructing the water passing through downpipe 20. It should be noted, however, that other types of flow meters (e.g., invasive meters such as turbine wheel meters) could be utilized, if desired.

As discussed above, transducers 38 may be mounted to engage the outside of downpipe 20 via unit 30 and be regulated (powered and controlled) by control board 124 (e.g., by power converter 122 and processor 133). Each transducer 38 may generate waves that pass through the annular wall of downpipe 20 and reflect off the water for detection by the other transducer 38. Signal processor 126 (and/or processor 133) may measure the time it takes for the waves to travel between transducers 38 and calculate a velocity of the water based on the time. This velocity can be used by signal processor 126 (and/or processor 133) to determine a flowrate of the water through downpipe 20. Signal processor 126 may generate one or more signals indicative of the velocity and/or flowrate and direct the signal(s) to processor 133 for further processing.

In some embodiments, it may be difficult to get a desired level of contact between transducers 38 and the outer annular surface of downpipe 20. Spacing between these components can create noise that reduces an accuracy of the calculations described above. To improve the level of contact between transducers 38 and downpipe 20, it may be possible to coat one or both of these surfaces with a grease, a gel, a tape, or another compliant material (not shown) that inhibits air from entering the interface between the surfaces.

Processor 133 may communicate with power sensor 128 to determine an amount of power being consumed by pump 18 during generation of the water flow through downpipe 20. In the disclosed embodiment, power sensor 128 is an induction-type power sensor. Power sensor 128 may include a split- or solid-core designed to pass around at least one phase of power line 22 extending to pump 18. Power sensor 128 may be configured to generate a signal indicative of the power (e.g., of the current) being consumed by pump 18, and to direct that signal to processor 133 for further processing. It is contemplated that another (e.g., non-induction) type of sensor may be used for this purpose, if desired.

Processor 133 may communicate directly with switch 130 to indirectly regulate operation of switch 132. For example, switch 130 may selectively be provided with low-voltage direct-current from control board 124 and used to direct high-voltage alternating-current to switch 132. Switch 132 may, in turn, use the high-voltage alternating current to selectively interrupt the supply of high-voltage alternating current from pump controller 24 to pump 18. In this way, hub 32 may be able to selectively turn off pump 18, even when pump controller 24 is requesting activation of pump 18. It is contemplated that switch 130 may be omitted and that processor 133 may directly control switch 132 in some applications.

Switch 130 may be moveable between two positions. In a first position, the high-voltage alternating-current from pump controller 24 may be directed to switch 132. In a second position, the high-voltage alternating-current may be blocked by switch 130 from reaching switch 132. Processor 133 may selectively generate a first low-voltage signal causing switch 130 to move to the first position or alternatively selectively generate a second low-voltage signal causing switch 130 to move to the second position. Switch 130 may normally default to the second position. It is contemplated, however, that other types of switches may be utilized for the purposes of this disclosure.

Switch 132 may likewise be moveable between two positions. In a first position, the high-voltage alternating current from pump controller 24 may be directed through switch 132 to pump 18. In a second position, the high-voltage alternating current from pump controller 24 may be blocked by switch 132 from passing to pump 18. Switch 132 may default to its first position and only be moved to its second position when switch 130 is moved to its corresponding first position. In other words, when switch 130 is energized to direct power to switch 132, pump 18 may be non-operational. Similarly, when switch 130 is de-energized and does not direct power to switch 132, pump 18 may be directly regulated by pump controller 24. In this way, switch 130 may only need to be energized when an override of pump controller 24 is desired. It is contemplated, however, that other strategies may be implemented, if desired.

Cap 102 may be configured to engage collar 94 and enclose mount 98 and system 100 (referring to FIG. 6). In the disclosed embodiment, cap 102 is cylindrical and hollow, having an open end that engages collar 94 and a closed end located opposite the open end. A periphery at the open end of cap 102 may protrude outward at an assembly location generally aligned with notch 118 of collar 94. This protrusion may accommodate power line 22 bending over the upper lip of collar 94 at notch 118. In some embodiments, cap 102 may also be provided with one or more indexing features to ensure proper alignment with low-voltage mount 98. For example, one or more channels 136 may be formed within an inner annular surface of cap 102 that are configured to engage one or more similar ridges 138 formed within an outer surface of mount 98. With this configuration, once cap 102 is properly assembled over mount 98, a relative rotation between these components may be inhibited. It is contemplated that other types and/or numbers of indexing features may be utilized, if desired. Alternatively or additionally, one or more retention members (e.g., threaded fasteners) may be inserted through the perimeter of cap 102 into collar 94 and/or mount 98 to inhibit relative rotations.

Some or all of the components described above may be fabricated from materials chosen to withstand environmental conditions (UV damage, freezing, corrosion, etc.) over long periods of time. For example, these components may be fabricated from plastics, composites, and/or alloys (e.g., stainless steel, brass, aluminum, etc.). Seals may be disposed between/around these components to inhibit moisture, dust, insects, and other contaminates from entering hub 32 and/or casing 16.

In some embodiments, care may be taken to avoid inadvertently dropping components into well 10. This care may include, for example, tethering one or more of the components of unit 30 (e.g., clamp 36, rod 40, pin 56, release mechanism 74, etc.) to hub 32 (e.g., via ring 116). Tether(s) 117 may embody, for example, stainless-steel cables or chains. In some embodiments, tether(s) 117 may be color coded.

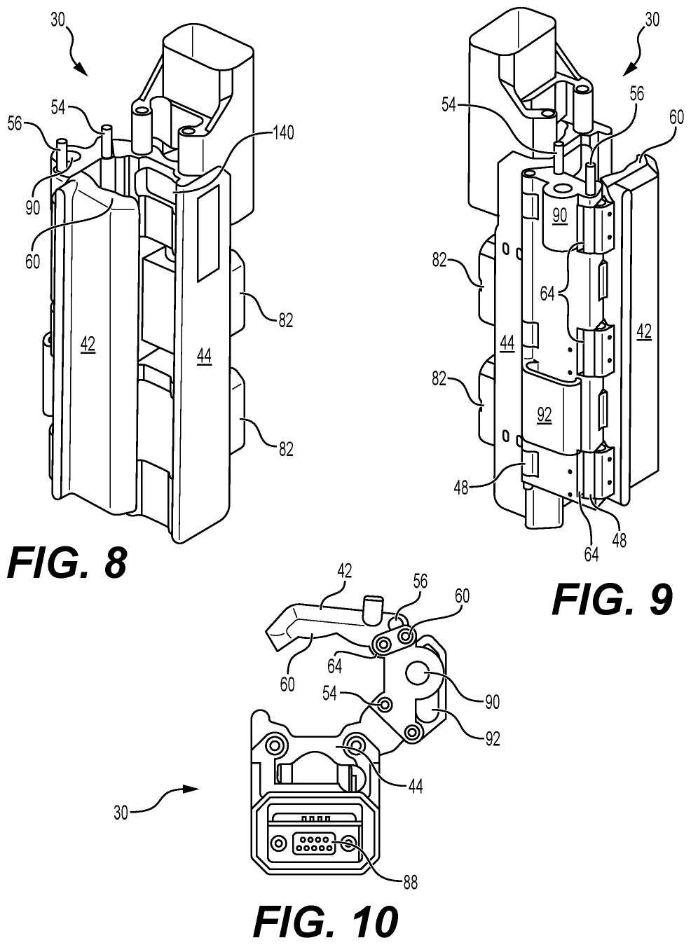

FIGS. 8, 9, and 10 illustrate an alternative embodiment of sensing unit 30. Similar to sensing unit 30 of FIGS. 1-6, sensing unit 30 of FIGS. 8-10 may include leaf 42 pivotally connected to leaf 44 via pins 54 and 56, engagement member 60, biasing members 64, pockets 80 and covers 82 to receive sensors 38, electrical connection 88, bore 90 to receive rod 40, and lead-guide 92, among other things. However, in contrast to the embodiment of FIGS. 1-6, in sensing unit 30 of FIGS. 8-10, biasing members 64 may embody torsion springs instead of tension/compression springs, and engagement member 64 may be integrally formed at or otherwise connected to an internal surface of leaf 42. In this configuration, rather than functioning to translate engagement member 64 towards downpipe 20 (referring to FIG. 1), biasing members 64 may instead rotate engagement member 64 together with leaf 42 towards downpipe 20. This may result in a more compact solution that has a lower tendency to bind when moving.

In the configuration of FIGS. 8-10, tapered pin 56 may function to release leaf 42, such that the bias of members 64 is allowed to pivot leaf 42 from an open or installed position to a closed or engaged position. Additionally, electrical connections 88 from the separate transducers 38 may converge at a connection point located at an upper end of sensing unit 30, such that only a single signal cable is required to pass from sensing unit 30 to hub 32.

As also shown in FIGS. 8 and 9, sensing unit 30 may include an additional sensor 140 located at the upper end of sensing unit 30. In one embodiment, sensor 140 is a temperature sensor configured to engage an outer surface of downpipe 20 and generate a signal indicative of a temperature of the water flowing through downpipe 20. This signal may be directed to hub 32 via the single signal cable described above.

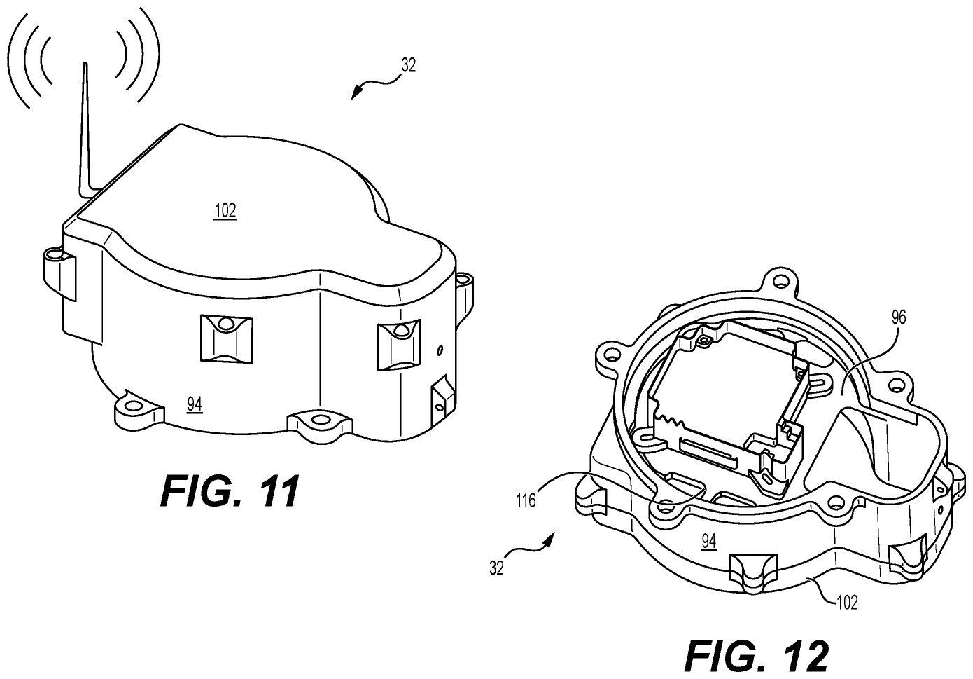

FIGS. 11 and 12 illustrate an alternative hub 32. While hub 32 of FIGS. 11 and 12 may include nearly identical electrical components to those of hub 32 shown in FIG. 6, a configuration of collar 94 and cap 102 may be different. For example, rather than separate high/low voltage platform and mount, a single platform is provided within collar 94. In this embodiment, high- and low-voltage components may be mounted to opposing sides of the same platform. In addition, rather than collar 94 engaging casing 16 directly, an existing adapter (e.g., from an old cap removed from an existing well) may be left in place and re-used. The design of FIGS. 11 and 12 may reduce a size and cost associated molds used to form collar 94 and/or cap 102.

### INDUSTRIAL APPLICABILITY

The disclosed system may be used to continuously monitor the operation and health of a well. This may include, among other things, monitoring a health of individual well components, monitoring a capacity of a geographical area to provide water to (e.g., to replenish) the well over an extended period of time, and/or monitoring user-specific consumption parameters. The disclosed system may also be used to remotely control well usage (e.g., to selectively override operation of pump controller 24 and turn off pump 18). Operation of system 12 will now be explained in detail.

Before installation of system 12, it may be important to determine parameters of downpipe 20. For example, it may be important to determine if downpipe 20 is made from PVC, GS, or another material, and what the external diameter and wall thickness are. In some applications, the material of downpipe 20 may be visually discerned (e.g., based on color and relative size). However, in other applications, downpipe 20 may be submerged, corroded, and/or too shadowed within casing 16 to make visual observations possible. In these situations, a go/no-go device may be provided with system 12 to aid in determining the material and/or diameter of downpipe 20.

In one embodiment, the go/no-go device is a generally C-shaped device having an inner diameter large enough to receive a downpipe 20 with an outer diameter of 1 in., yet small enough to block reception of a downpipe 20 having an outer diameter of 1.25 in. In this same embodiment, the go/no-go device may be fitted with a magnet and/or a simple circuit that can be used to discern between magnetic/conductive GS and non-magnetic/non-conductive PVC. The device may be connectable to rod 40 described above and lowered by a user down past pitless adapter 28 and placed against downpipe 20. When downpipe 20 fits into the device, downpipe 20 may be determined to have an outer diameter of 1 in. or less—otherwise, downpipe 20 may be determined to have a diameter of larger than 1 in. When the user feels an attraction between the device and downpipe 20 or the associated circuit is completed (e.g., as observed by an illuminated LED and/or the sounding of a buzzer), downpipe 20 may be determined to be fabricated from GS—otherwise, downpipe 20 may be determined to be fabricated from PVC. Based on the size and material of downpipe 20, the user may selectively adjust the axial spacing between transducers 38 in unit 30 accordingly.

It should be noted that before lowering any components into well 10, each component should be anchored above ground via tether(s) 117. For example, during the use of the go/no-go device, rod 40 should be connected to a lower end of tether 117, and the upper end of tether 117 should be connected to something that cannot fit into casing 16 (e.g., to ring 116 of collar 94). Further descriptions of the usages of tether(s) 17 will be omitted from this disclosure.

To install system 12, collar 94 may be placed over the open end of casing 16 (or against an existing adapter, when using the embodiment of FIGS. 8-10), and setscrews 112 may be tightened (referring to FIG. 6) to hold collar 94 in place. Rod 40 may be removed from the go/no-go device and connected to unit 30. Unit 30 may be preloaded (e.g., cocked in the manner described above), power line 22 may be inserted into guide 92, and the engagement surfaces of transducers 38 may be coated with the appropriate gel and/or tape. Thereafter, unit 30 may be lowered into casing 16 using rod 40, such that downpipe 20 is placed radially between member 60 and leaf 44. The user may then pull on the tether 117 that is color-coded to correspond with release mechanism 74 (or pin 56) to release protrusions 68 and allow leaf 42 to extend (e.g., to translate or pivot radially inward) toward downpipe 20. As described above, this extension may sandwich downpipe 20 between leaves 42, 44 and press transducers 38 against the outer surface of downpipe 20.

High-voltage platform 96 may then be placed into collar 94 and secured in place (if not already integral to collar 94, as in FIG. 12). Electrical connections may then be made between the lower end of power line 22 and lug 120 and between the upper end of power line 22 and switch 132, followed by the installation of low-voltage mount 98 and processing system 100 (also if not already integral to collar 94). Connections 88 of transducers 38 may be connected to signal processor 126. Some or all of the low-voltage circuitry of processing system 100 may be preconnected and preassembled into low-voltage mount 98, such that once power is supplied from pump controller 24 to lug 120, processing system 100 may be energized. After the required connections are made and processing system 100 has successfully been energized, cap 102 may be lowered over low-voltage mount 98 and secured in place.

During operation of system 12, processing system 100 may monitor the flowrate of water through downpipe 20 and the amount of power (e.g., current) used by pump 18 to generate that flowrate. In some applications (e.g., FIGS. 8-10), a temperature of the water passing through downpipe 20 may also be monitored.

For example, power directed to lug 120 may be received by power converter 122, signal conditioner 126 and transducers 38 of unit 30. Transducers 38 may begin generating signals indicative of the flowrate through downpipe 20; power sensor 128 may begin generating signals indicative of the amount of power consumed by pump 18 to generate the flowrate; sensor 140 may begin generating signals indicative of the water temperature; and control board 124 (energized by low-voltage direct current from power converter 122) may receive and process these signals.

Control board 124 (e.g., the processor(s) of control board 124) may use the flowrate signals (e.g., as received via signal conditioner 126), the power consumption signals, and/or the temperature signal to determine many different health parameters of well 10. For example, the signals may be used to determine a velocity of the water, a flowrate of the water, differences from historical values, maximum values over a period of time, a total amount of water pumped over a given period, and other flow-related parameters. Each of these parameters may be communicated wirelessly to and graphically displayed on portal 34.

The velocity parameter, the flowrate parameter, the temperature, and/or the amount of power consumed by pump 18 to produce the flowrate may be used by processor 133 to determine a dynamically varying depth (i.e., distance from the open end of casing 16 to a surface) of the water within well 10. This may be accomplished using equations 1-3 below:

$$Depth = \frac{\dot{P} ( η )}{ρ gQ} - \frac{{α ( \frac{Q}{A} )}^{2}}{2 g} - \frac{{( \frac{Q}{A} )}^{2}}{2 g} [ \int \frac{1}{D} + {NK}_{l} ] - \frac{{P}_{2}}{ρ g} \qquad EQ . 1$$

wherein:
   \dot{P} is a power (W) detected via sensor 128;
   η is a known efficiency (%) of pump 18;
   ρ is the density of water (999.8 kg/m²);
   g is gravity (9.8 m/sec²);
   Q is the flowrate (m³/sec) detected by unit 30;
   α is either 1 if the flow is turbulent or 2 if the flow is laminar (laminar flow is generally assumed);
   A is a cross-sectional area (m²) inside of downpipe 20;
   f is a friction factor determined based on EQ. 2 below;
   D is the internal diameter of downpipe 20;
   N is the number of unions in downpipe 20; and
   Kₗ is a constant corresponding to a type of unions within downpipe 20.

$$f = \frac{1}{{( - 1.8 {log}_{10} [ {( \frac{( \frac{∈}{D} )}{3.7} )}^{1.11} + \frac{6.9}{Re} ] )}^{2}} \qquad EQ . 2$$

wherein:
   E is a material constant (0 for plastic, 0.15 for galvanized steel);
   D is the internal diameter of downpipe 20; and
   Re is the Reynolds number calculated using EQ. 3 below.

$$Re = \frac{ρ u D}{μ} \qquad EQ . 3$$

wherein:
   ρ is the density of water (999.8 kg/m²);
   u is the velocity (m/sec) detected by unit 30;
   u is the dynamic viscosity of ground water (1.13e⁻³ N*s/m²);
   D is the internal diameter of downpipe 20.

In one embodiment, one or more of the parameters (e.g., the density and/or viscosity of the water flowing through downpipe 20) listed above may be assumed based on typical conditions encountered in a particular geographical area. However, in other embodiments, these conditions may be directly measured and referenced by processor 133 with one or more maps stored in the memory of control board 124. For example, the temperature of the water flowing through downpipe 20 may be detected (e.g., via sensor 140 located within unit 30, referring to FIG. 8) and referenced with the maps to determine a site-specific density and/or viscosity.

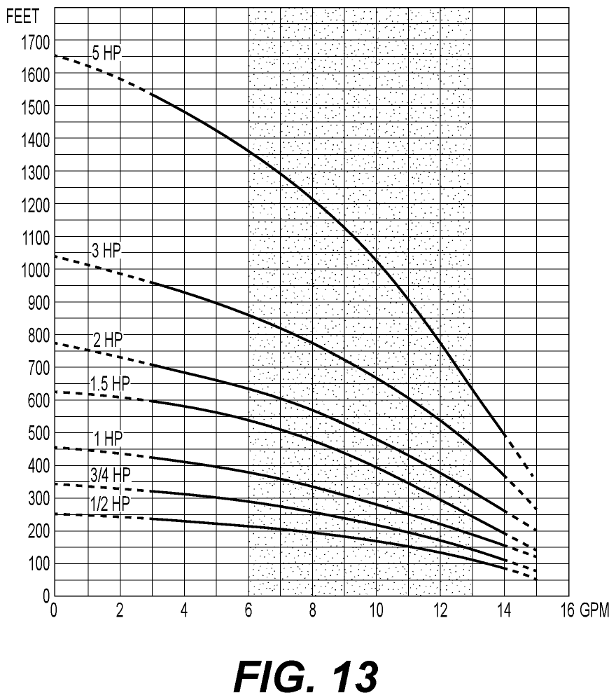

In an alternative embodiment, rather than using EQ. 1-3 above to determine the depth of water within well 10, a pump control chart similar that shown in FIG. 13 may be used. For example, based on a known power rating of pump 18 and the flowrate detected via unit 30, processor 133 may be configured to reference the chart of FIG. 13 and directly determine the depth of water within well 10. It is contemplated that a combination of using equations 1-3 and the chart of FIG. 13 may be implemented, if desired.

In some embodiments, alerts may be generated on portal 34 in response to parameters measured and/or determined for well 10. For example, a low-water alert may be generated when it is determined that the depth of well 10 has dropped below a minimum level and/or when pump 18 is pumping little or no water. In another example, a leak alert may be generated when water flow through downpipe 20 is detected during a time when no flow should be detected (e.g., during the middle of the night, during a vacation period, etc.). The leak alert may also or alternatively be generated based on an amount of water pumped through downpipe 20 being more than an average and/or historical amount.

In some embodiments, graphical representations of the well-related parameters may be shown on a display of portal 34. For example, values and/or traces associated with the flowrate, the velocity, the temperature, an amount of water pumped, the current being consumed, etc. may be shown in any desired manner.

As described above, system 12 may be configured to selectively interrupt operation of pump 18 (e.g., override regulation of pump controller 24). In one example, this interruption may be in response to a detected low-water event (e.g., such that pump 18 does not overheat) or leak event (e.g., to prevent flooding). In another example, the interruption may be remotely requested by a user via portal 34. In yet another embodiment, the interruption may be triggered by a regulating authority (e.g., based on an actual consumption amount exceeding an allowed amount). In some applications, the user may be warned prior to and/or alerted to the override situation (e.g., via a notification displayed on portal 34).

It will be apparent to those skilled in the art that various modifications and variations can be made to the disclosed system. Other embodiments will be apparent to those skilled in the art from consideration of the specification and practice of the disclosed system. For example, while unit 30 is described above and shown in the figures as being located within casing 16 at a location between pitless adapter 28 and pump 18, it is contemplated that in some applications unit 30 could alternatively be located outside of casing 16 and clamped around conduit 26. In another example, it may be useful to include a depth sensor located at a lower end of sensing unit 30 to detect a surface depth of the water in bore 14. This detected depth may be used to calibrate and/or augment calculations made by sensing unit 30, if desired. It is intended that the specification and examples be considered as exemplary only, with a true scope being indicated by the following claims and their equivalents.

What is claimed is:

1. A system for monitoring a well having a pump disposed within a bore to pump fluid out of the bore through a pipe, the system comprising:
a sensing unit having a device that is remotely operatable to press at least one sensor toward the pipe, the at least one sensor being configured to generate a flowrate signal indicative of a flowrate of the fluid through the pipe; and
a hub connected to the sensing unit and configured to receive the signal.

2. The system of claim 1, wherein:
the well includes a casing inside the bore;
the sensing unit is configured to connect to the pipe at a location inside the casing; and
the hub is mount to an end of the case extending from the bore and remote from the sensing unit.

3. The system of claim 1, further including at least one of a rod or a tether extending from the hub to the sensing unit.

4. The system of claim 1, wherein:
the sensor is a transducer; and
the sensing unit includes two transducers located at a same side of the pipe in an axially spaced-apart configuration.

5. The system of claim 1, wherein the hub is configured to determine a depth of water within the bore based on the flowrate signal.

6. The system of claim 5, further including a temperature sensor located in the sensing unit and configured to generate a temperature signal indicative of the water flowing through the pipe, wherein the hub is configured to determine the depth based further on the temperature signal.

7. The system of claim 5, further including a power sensor located in the hub and configured to generate a power signal indicative of an amount of power being consumed by the pump during fluid flow through the pipe, wherein the hub is configured to determine the depth based further on the power signal.

8. The system of claim 1, wherein the device is a clamp configured to at least partially enclose the pipe.

9. The system of claim 8, wherein the clamp includes:
a first leaf;
a second leaf;
a pivot pin removably connecting the first leaf to the second leaf;
a lock pin inhibiting pivoting of the first leaf relative to the second leaf; and
a biasing mechanism configured to cause the pipe to be sandwiched between the first and second leaves.

10. The system of claim 1, wherein the sensing unit and the hub include power connections configured to allow a power line extending between the pump and a pump controller located outside of the well to power the hub and the sensing unit.

11. The system of claim 10, wherein the sensing unit and the hub only receive shore power when the pump is energized by the pump controller.

12. The system of claim 11, wherein the hub is configured to selectively interrupt a supply of power from the pump controller to the pump.

13. The system of claim 11, wherein the hub is configured to selectively interrupt the supply of power based on at least one of the depth or the flowrate.

14. The system of claim 11, wherein the hub is configured to selectively interrupt the supply of power based on a signal from a remote portal in wireless communication with the hub.

15. A system for monitoring a well having a pump disposed within a bore to pump fluid out of the bore through a pipe, the system comprising:
a sensing unit configured to generate a flowrate signal indicative of a flowrate of the fluid through the pipe; and
a hub in communication with the sensing unit and configured to determine a depth of water in the bore based on the flowrate signal and an amount of power consumed by the pump.

16. The system of claim 15, further including a power line directed through the hub to the pump, wherein the hub is configured to selectively interrupt a supply of power to the pump.

17. The system of claim 16, wherein the hub and the sensing unit are powered via the power line.

18. A method of monitoring a well, comprising:
using a sensing unit located inside of a well casing to generate a flowrate signal indicative of a flowrate of water pumped by a pump submerged in the well; and
using a hub located remotely from the sensing unit to determine a depth of water in the well based on the flowrate signal.

19. The method of claim 18, further including using the hub to selectively interrupt a supply of power from a pump controller to the pump.

20. The method of claim 18, further including using a power sensor in the hub to generate a power signal indicative of an amount of power consumed by the pump, wherein determining the depth includes determining the depth based further on the power signal.
